(19) United States
(12) Patent Application Publication
(10) Pub. No.: US 2013/0065205 A1
(43) Pub. Date: Mar. 14, 2013

(54) APPARATUS AND METHOD FOR GENERATING VOCAL ORGAN ANIMATION

(71) Applicant: Bong-Rae Park, Seoul (KR)

(72) Inventor: Bong-Rae Park, Seoul (KR)

(73) Assignee: CLUSOFT CO., LTD., Seoul (KR)

(21) Appl. No.: 13/695,572

(22) PCT Filed: May 31, 2010
(86) PCT No.: PCT/KR10/03484

§ 371 Date: Oct. 31, 2012

(30) Foreign Application Priority Data
May 31, 2010 (KR) 10-2010-0051369

(51) Int. Cl. G09B 19/06

(52) U.S. Cl. 434/157; 434/167

(57) ABSTRACT

The present disclosure relates to an apparatus and method for generating a vocal organ animation very similar to a pronunciation pattern of a native speaker in order to support foreign language pronunciation education. The present disclosure checks an adjacent phonetic value in phonetic value constitution information, extracts a detail phonetic value based on the adjacent phonetic value, extracting pronunciation pattern information corresponding to the detail phonetic value and pronunciation pattern information corresponding to a transition section allocated between detail phonetic values, and performs interpolation to the extracted pronunciation pattern information, thereby generating a vocal organ animation.

### CROSS-REFERENCE TO RELATED APPLICATION

The present application is a national phase entry of International Application No. PCT/KR2010/003484 filed on May 31, 2010, which claims priority to Korean Patent Application No. 10-2010-0051369 filed in the Republic of Korea on May 31, 2010, the disclosures of which are incorporated herein by reference.

### TECHNICAL FIELD

The present disclosure relates to a technique for generating a vocal organ animation from a vocalization procedure, and more particularly, to an apparatus and method for generating a vocal organ animation to show that each pronunciation is differently articulated according to an adjacent pronunciation.

### BACKGROUND ART

With the advancement of modern communication and transportation, globalization is accelerated to reduce the time and space constraints that separate one country from another. As globalization increases, the people try to acquire foreign language skills and organizations such as school and companies want students and employees with the ability to speak many languages.

In order to learn a foreign language, it is not just a matter of memorizing words and learning grammar, but also learning the correct pronunciation. For example, learning the native pronunciation not only gives a good command of a language but also allows one to understand the language better.

Korean Unexamined Patent Publication No. 2009-53709 (entitled “apparatus and method for displaying pronunciation information), filed by the applicant of this application, discloses such a method for generating an animation about pronunciation patterns of native speakers. In this publication, articulator status information corresponding to each phonetic value is stored, and then, if a series of phonetic values are given, a vocal organ animation is generated based on the corresponding articulator status information and displayed on a screen to provide information about pronunciation patterns of native speakers to a learner. In addition, in this publication, the vocal organ animation is very similar to pronunciation patterns of native speakers by reflecting a vocalization speed of a word or pronunciation phenomenon such as abbreviation, shortening and emitting.

### DISCLOSURE

### Technical Problem

However, when a specific pronunciation is to be vocalized among a series of pronunciations, articulators tend to prepare a following pronunciation in advance, which is linguistically called ‘economy in pronunciation’. For example, in English, in the case a /r/ pronunciation is located in succession to a preceding pronunciation seemingly unrelated to the movement of the tongue such as /b/, /p/, /m/, /f/, and /v/, the tongue tends to prepare the /r/ pronunciation in advance while the preceding pronunciation is being vocalized. In addition, in English, in the case pronunciations requiring the direct movement of the tongue are in succession, a present pronunciation tends to be vocalized in a different way from a standard phonetic value according to a following pronunciation so that the following pronunciation may be vocalized more easily.

The applicant has found that the economy in pronunciation is not effectively reflected in the above publication. In other words, in the above publication, a pronunciation pattern of a native speaker where a phonetic value changes according to an adjacent phonetic value is not appropriately reflected in an animation, and so the vocal organ animation may be different from an actual pronunciation pattern of a native speaker.

The present disclosure is designed to solve the problems of the prior art, and therefore it is an object of the present disclosure to provide an apparatus and method for generating a vocal organ animation by reflecting a pronunciation pattern of a native speaker which changes according to an adjacent pronunciation.

Other objects and advantages of the present disclosure will be understood from the following descriptions and become apparent by the embodiments of the present disclosure. In addition, it is understood that the objects and advantages of the present disclosure may be implemented by components defined in the appended claims or their combinations.

### Technical Solution

In one aspect of the present disclosure, there is provided a method for generating a vocal organ animation corresponding to phonetic value constitution information which is information about a phonetic value list to which vocalization lengths are allocated, by using an apparatus for generating a vocal organ animation, the method including: a transition section assigning step for assigning a part of vocalization lengths of every two adjacent phonetic values included in the phonetic value constitution information as a transition section between the corresponding two adjacent phonetic values; a detail phonetic value extracting step for checking an adjacent phonetic value of each phonetic value included in the phonetic value constitution information and then extracting a detail phonetic value corresponding to each phonetic value based on the adjacent phonetic value to generate a detail phonetic value list corresponding to the phonetic value list; a reconstituting step for reconstituting the phonetic value constitution information by including the generated detail phonetic value list in the phonetic value constitution information; a pronunciation pattern information detecting step for detecting pronunciation pattern information corresponding to each detail phonetic value and each transition section included in the reconstituted phonetic value constitution information; and an animation generating step for generating a vocal organ animation corresponding to the phonetic value constitution information by assigning the detected pronunciation pattern information based on the vocalization length of each detail phonetic value and the transition section and performing interpolation to the assigned pronunciation pattern information.

Preferably, the animation generating step generates a vocal organ animation by assigning pronunciation pattern information detected for each detail phonetic value to a start point and an end point corresponding to the vocalization length of the detail phonetic value and performing interpolation to the pronunciation pattern information assigned to the start point and the end point.

In addition, the animation generating step generates a vocal organ animation by assigning zero or at least one kind of pronunciation pattern information detected for each transition section to the corresponding transition section and performing interpolation to each pair of adjacent pronunciation pattern information existing from pronunciation pattern information of a detail phonetic value just before the transition section till pronunciation pattern information of a following detail phonetic value.

In another aspect of the present disclosure, there is also provided a method for generating a vocal organ animation corresponding to phonetic value constitution information which is information about a phonetic value list to which vocalization lengths are allocated, by using an apparatus for generating a vocal organ animation, the method including: a transition section assigning step for assigning a part of vocalization lengths of every two adjacent phonetic values included in the phonetic value constitution information as a transition section between the corresponding two adjacent phonetic values; a detail phonetic value extracting step for checking an adjacent phonetic value of each phonetic value included in the phonetic value constitution information and then extracting a detail phonetic value corresponding to each phonetic value based on the adjacent phonetic value to generate a detail phonetic value list corresponding to the phonetic value list; a reconstituting step for reconstituting the phonetic value constitution information by including the generated detail phonetic value list in the phonetic value constitution information; an articulation symbol extracting step for extracting an articulation symbol of each articulator which corresponds to each detail phonetic value included in the reconstituted phonetic value constitution information; an articulation constitution information generating step for generating articulation constitution information of each articulator which includes the extracted articulation symbol, the vocalization length of each articulation symbol and the transition section; a pronunciation pattern information detecting step for detecting pronunciation pattern information of each articulator which corresponds to each articulation symbol included in the articulation constitution information and each transition section assigned between articulation symbols; and an animation generating step for assigning the detected pronunciation pattern information based on the vocalization length of each articulation symbol and the transition section and then performing interpolation to the assigned pronunciation pattern information to generate an animation of each articulator which corresponds to the articulation constitution information, and composing the generated animations to generate a single vocal organ animation corresponding to the phonetic value constitution information.

Preferably, the articulation constitution information generating step includes checking how much an articulation symbol extracted corresponding to each detail phonetic value participates in vocalization of the corresponding detail phonetic value (hereinafter, referred to as “the degree of vocalization involvement”); and resetting a vocalization length of each articulation symbol or a transition section assigned between articulation symbols according to the checked degree of vocalization involvement.

More preferably, the animation generating step generates an animation of each articulator corresponding to the articulation constitution information by assigning pronunciation pattern information detected for each articulation symbol to a start point and an end point corresponding to the vocalization length of the corresponding articulation symbol and performing interpolation to the pronunciation pattern information assigned to the start point and the end point.

Further, the animation generating step generates an animation of each articulator corresponding to the articulation constitution information by assigning zero or at least one kind of pronunciation pattern information detected for each transition section to the corresponding transition section and performing interpolation to each pair of adjacent pronunciation pattern information existing from pronunciation pattern information of an articulation symbol just before the transition section till pronunciation pattern information of a following articulation symbol.

In still another aspect of the present disclosure, there is also provided an apparatus for generating a vocal organ animation corresponding to phonetic value constitution information which is information about a phonetic value list to which vocalization lengths are allocated, the apparatus including: a transition section assigning means for assigning a part of vocalization lengths of every two adjacent phonetic values included in the phonetic value constitution information as a transition section between the corresponding two adjacent phonetic values; a phonetic value context applying means for checking an adjacent phonetic value of each phonetic value included in the phonetic value constitution information, then extracting a detail phonetic value corresponding to each phonetic value based on the adjacent phonetic value to generate a detail phonetic value list corresponding to the phonetic value list, and reconstituting the phonetic value constitution information by including the generated detail phonetic value list in the phonetic value constitution information; a pronunciation pattern information detecting means for detecting pronunciation pattern information corresponding to each detail phonetic value and each transition section included in the reconstituted phonetic value constitution information; and an animation generating means for generating a vocal organ animation corresponding to the phonetic value constitution information by assigning the detected pronunciation pattern information based on the vocalization length of each detail phonetic value and the transition section and performing interpolation to the assigned pronunciation pattern information.

In further another aspect of the present disclosure, there is also provided an apparatus for generating a vocal organ animation corresponding to phonetic value constitution information which is information about a phonetic value list to which vocalization lengths are allocated, the apparatus including: a transition section assigning means for assigning a part of vocalization lengths of every two adjacent phonetic values included in the phonetic value constitution information as a transition section between the corresponding two adjacent phonetic values; a phonetic value context applying means for checking an adjacent phonetic value of each phonetic value included in the phonetic value constitution information, then extracting a detail phonetic value corresponding to each phonetic value based on the adjacent phonetic value to generate a detail phonetic value list corresponding to the phonetic value list, and reconstituting the phonetic value constitution information by including the generated detail phonetic value list in the phonetic value constitution information; an articulation constitution information generating means for extracting an articulation symbol of each articulator which corresponds to each detail phonetic value included in the reconstituted phonetic value constitution information and then generating articulation constitution information of each articulator which includes the extracted one or more articulation symbols, the vocalization length of each articulation symbol and the transition section; a pronunciation pattern detecting means for detecting pronunciation pattern information of each articulator which corresponds to each articulation symbol included in the articulation constitution information and each transition section assigned between articulation symbols; and an animation generating means for assigning the detected pronunciation pattern information based on the vocalization length of each articulation symbol and the transition section and then performing interpolation to the assigned pronunciation pattern information to generate an animation of each articulator which corresponds to the articulation constitution information, and composing the generated animations to generate a single vocal organ animation corresponding to the phonetic value constitution information.

### Advantageous Effects

The present disclosure may generate a vocal organ animation very similar to a pronunciation pattern of a native speaker by reflecting an articulation procedure where each pronunciation is articulated differently according to an adjacent pronunciation.

In addition, the present disclosure may contribute to pronunciation correction of a foreign language learner by generating an animation about a pronunciation pattern of a native speaker and providing the animation to the foreign language learner.

Further, the present disclosure may implement a more accurate and natural vocal organ animation since the animation is generated based on pronunciation pattern information classified by articulators such as the lips, the tongue, the nose, the uvula, the palate, the teeth and the gum, which are used for vocalization.

### DESCRIPTION OF DRAWINGS

The accompanying drawings illustrate preferred embodiments of the present disclosure and, together with the foregoing disclosure, serve to provide further understanding of the technical spirit of the present disclosure. However, the present disclosure is not to be construed as being limited to the drawings.

FIG. 1 is a diagram showing an apparatus for generating a vocal organ animation according to an embodiment of the present disclosure;

FIG. 2 is a diagram showing phonetic value constitution information which is information about a phonetic value list to which vocalization lengths are allocated according to an embodiment of the present disclosure;

FIG. 3 is a diagram showing phonetic value constitution information to which transition section are assigned according to an embodiment of the present disclosure;

FIG. 4 is a diagram showing phonetic value constitution information including detail phonetic values according to an embodiment of the present disclosure;

FIG. 5 is a diagram showing a vocal organ animation to which a key frame and a general frame are assigned according to an embodiment of the present disclosure;

FIG. 6 is a diagram showing an interface displaying a generated animation and relevant information, provided by the apparatus for generating a vocal organ animation according to an embodiment of the present disclosure;

FIG. 7 is a flowchart for illustrating a method for generating a vocal organ animation corresponding to the phonetic value constitution information by the apparatus for generating a vocal organ animation according to an embodiment of the present disclosure;

FIG. 8 is a diagram showing an apparatus for generating a vocal organ animation according to another embodiment of the present disclosure;

FIG. 9 is a diagram showing articulation constitution information of each articulator according to another embodiment of the present disclosure;

FIG. 10 is a diagram showing an interface displaying a generated animation and relevant information, provided by the apparatus for generating a vocal organ animation according to another embodiment of the present disclosure; and

FIG. 11 is a flowchart for illustrating a method for generating a vocal organ animation corresponding to the phonetic value constitution information by the apparatus for generating a vocal organ animation according to another embodiment of the present disclosure.

<Reference Symbols>

| | |
|---|---|
| 101: input unit | 102: phonetic value |
| | information storing |
| | unit |
| 103: phonetic value constitution | |
| information generating unit | |
| 104: transition section information | |
| storing unit | |
| 105: transition section allocating unit | |
| 106: phonetic value context information | |
| storing unit | |
| 107: phonetic value context applying unit | |
| 108, 803: pronunciation pattern information | |
| storing unit | |
| 109, 804: pronunciation pattern detecting | |
| unit | |
| 110, 805: animation generating unit | |
| 111, 806: display unit | 112, 807: animation |
| | coordinating unit |
| 801, 806: articulation symbol information | |
| storing unit | |
| 802: articulation constitution information | |
| generating unit | |

### BEST MODE

The above objects, features and advantages will be more apparent through the following detailed description in relation to the accompanying drawings, and accordingly the technical spirit of the present disclosure can be easily implemented by those having ordinary skill in the art. In addition, if detailed description of a known technique relating to the present disclosure can make the substance of the present disclosure unnecessarily vague, the detailed description will be omitted. Hereinafter, a preferred embodiment of the present disclosure will be described in detail with reference to the accompanying drawings.

Prior to describing an apparatus and method for generating a vocal organ animation according to an embodiment of the present disclosure, terms used herein will be described.

A phonetic value means a sound value of each phoneme of a word.

Phonetic value information represents a list of phonetic values which constitute sound values of a word.

Phonetic value constitution information means a list of phonetic values to which vocalization lengths are allocated.

A detail phonetic value means a sound value with which each phonetic value is actually vocalized according to a preceding and/or following phonetic value context, and each phonetic value has at least one detail phonetic value.

A transition section means a time region for a transition process from a preceding first phonetic value to a following second phonetic value, when a plurality of phonetic values is vocalized in succession.

Pronunciation pattern information is information relating to the shape of an articulator, when a detail phonetic value or an articulation symbol is vocalized.

An articulation symbol is information representing the shape of each articulator with a recognizable symbol when a detail phonetic value is vocalized by each articulator. The articulator means a body organ used for making a voice such as the lips, the tongue, the nose, the uvula, the palate, the teeth and the gum.

Articulation constitution information is information constituted as a list including an articulation symbol, a vocalization length of the articulation symbol and a transition section as unit information and is generated based on the phonetic value constitution information.

Hereinafter, a preferred embodiment of the present disclosure will be described in detail with reference to the accompanying drawings.

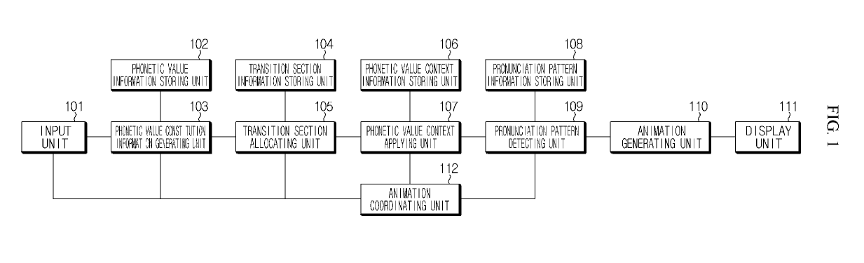

FIG. 1 is a diagram showing an apparatus for generating a vocal organ animation according to an embodiment of the present disclosure.

As shown in FIG. 1, an apparatus for generating a vocal organ animation according to an embodiment of the present disclosure includes an input unit 101, a phonetic value information storing unit 102, a phonetic value constitution information generating unit 103, a transition section information storing unit 104, a transition section allocating unit 105, a phonetic value context information storing unit 106, a phonetic value context applying unit 107, a pronunciation pattern information storing unit 108, a pronunciation pattern detecting unit 109, an animation generating unit 110, a display unit 111 and an animation coordinating unit 112.

The input unit 101 receives character information from a user. In other words, the input unit 101 receives character information including a phoneme, a syllable, a word, a phrase or a sentence from the user. Selectively, the input unit 101 receives voice information instead of the character information or receives both the character information and the voice information. Meanwhile, the input unit 101 may receive character information from a specific device or server.

The phonetic value information storing unit 102 stores phonetic value information of each word and also stores a general vocalization length or representative vocalization length of each phonetic value. For example, the phonetic value information storing unit 102 stores /bred/ as phonetic value information of a word ‘bread’, and stores vocalization length information of ‘T₁’ for the phonetic value /b/ included in /bred/, ‘T₂’ for the phonetic value /r/, ‘T₃’ for the phonetic value /e/, and ‘T₄’ for the phonetic value /d/, respectively.

Meanwhile, a general or representative vocalization length of a phonetic value is generally about 0.2 second for a vowel and about 0.04 second for a consonant. In case of vowels, a long vowel, a short vowel and a diphthong have different vocalization lengths. In case of consonants, a sonant, a voiceless consonant, a fricative, an affricate, a liquid and a nasal have different vocalization lengths. The phonetic value information storing unit 102 stores different kinds of vocalization length information according to such kinds of vowels or consonants.

If the character information is input by the input unit 101, the phonetic value constitution information generating unit 103 checks words arranged in the character information, extracts phonetic value information of each word and a vocalization length of the corresponding phonetic value from the phonetic value information storing unit 102, and generates phonetic value constitution information corresponding to the character information based on the extracted phonetic value information and the extracted vocalization length of each phonetic value. In other words, the phonetic value constitution information generating unit 103 generates phonetic value constitution information including at least one phonetic value corresponding to the character information and a vocalization length of each phonetic value.

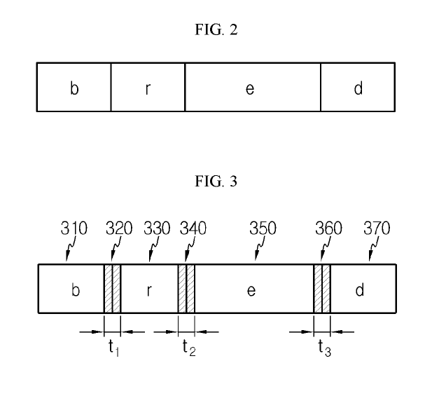

FIG. 2 is a diagram showing phonetic value constitution information which is information about a phonetic value list to which vocalization lengths are allocated according to an embodiment of the present disclosure. Referring to FIG. 2, the phonetic value constitution information generating unit 103 extracts /bred/ from the phonetic value information storing unit 102 as the phonetic value information of a word ‘bread’, and extracts a vocalization length of each phonetic value /b/, /r/, /e/, /d/ included in the phonetic value information from the phonetic value information storing unit 102. In other words, in the case the character information input by the input unit 101 is ‘bread’, the phonetic value constitution information generating unit 103 extracts phonetic value information corresponding to the ‘bread’ (namely, /bred/) and a vocalization length of each phonetic value (namely, /b/, /r/, /e/, /d/) from the phonetic value information storing unit 102, and generates phonetic value constitution information including a plurality of phonetic values and a vocalization length of each phonetic value based thereon. In FIG. 2, the vocalization length of each phonetic value is depicted as a length of each block.

Meanwhile, in the case voice information is input together with the character information by the input unit 101, the phonetic value constitution information generating unit 103 generates phonetic value constitution information corresponding to the character information and the voice information by extracting the phonetic value information from the phonetic value information storing unit 102 and analyzing the vocalization length of each phonetic value by means of voice recognition.

In other cases, in the case only voice information is input by the input unit 101 without character information, the phonetic value constitution information generating unit 103 performs voice recognition with respect to the voice information to analyze and extract at least one phonetic value and a vocalization length of each phonetic value and then generates phonetic value constitution information corresponding to the voice information based thereon.

The transition section information storing unit 104 stores general or representative time information consumed during the transition of vocalization from each phonetic value to a following phonetic value adjacent thereto. In other words, if phonetic values are vocalized in succession, the transition section information storing unit 104 stores general or representative time information about a vocalization transition section for transition from a first vocalization to a second vocalization when phonetic values are vocalized in succession. Preferably, for the same phonetic value, the transition section information storing unit 104 stores different transition section time information depending on an adjacent phonetic value. For example, in the case a phonetic value /s/ is vocalized after a phonetic value /t/, the transition section information storing unit 104 stores transition section information of ‘t₄’ as transition section information between the phonetic value /t/ and the phonetic value /s/, and in the case a phonetic value /o/ is vocalized after a phonetic value /t/, the transition section information storing unit 104 stores transition section information of ‘t₅’ as transition section information between the phonetic value /t/ and the phonetic value /o/.

Table 1 below shows transition section information of each adjacent phonetic value, stored in the transition section information storing unit 104 according to an embodiment of the present disclosure.

TABLE 1

| Adjacent | Transition |
|---|---|
| phonetic value | section |
| information | information |
| B_r | t₁ |
| R_e | t₂ |
| E_d | t₃ |
| T_s | t₄ |
| T_o | t₅ |

. . .

Referring to Table 1, in the case a phonetic value /s/ is vocalized after a phonetic value /t/ (namely, T_s of Table 1), the transition section information storing unit 104 stores ‘t₄’ as the time information of the transition section between /t/ and /s/. In addition, in the case a phonetic value /r/ is vocalized after a phonetic value /b/ (namely, B_r of Table 1), the transition section information storing unit 104 stores ‘t₁’ as the transition section information between /b/ and /r/.

If the phonetic value constitution information is generated by the phonetic value constitution information generating unit 103, the transition section allocating unit 105 assigns a transition section between adjacent phonetic values of the phonetic value constitution information, based on the transition section information of each adjacent phonetic value stored in the transition section information storing unit 104. At this time, the transition section allocating unit 105 assigns a part of vocalization lengths of the adjacent phonetic values to which the transition section is assigned, as a vocalization length of the transition section.

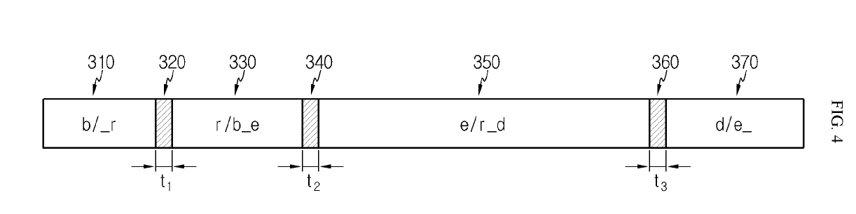

FIG. 3 is a diagram showing phonetic value constitution information to which transition section are assigned according to an embodiment of the present disclosure. Referring to FIG. 3, based on the transition section information of each adjacent phonetic value stored in the transition section information storing unit 104, in the phonetic value constitution information /bred/, the transition section allocating unit 105 assigns a transition section 320 of ‘t₁’ between phonetic values /b/ and /r/, assigns a transition section 340 of ‘t₂’ between phonetic values /r/ and /e/, and assigns a transition section 360 of ‘t₃’ between phonetic values /e/ and /d/. At this time, in order to ensure the time when the transition section of ‘t₁’ is assigned (namely, the transition section vocalization length), the transition section allocating unit 105 reduces vocalization lengths of adjacent phonetic values /b/ and /r/ adjacent to the transition section 320 of ‘t₁’. Similarly, in order to ensure transition sections 340, 360 of ‘t₂’ and ‘t₃’, the transition section allocating unit 105 reduces vocalization lengths of phonetic values /r/, /e/, /d/. Accordingly, in the phonetic value constitution information, the vocalization lengths 310, 330, 350, 370 of phonetic values and the transition sections 320, 340, 360 are distinguished from each other.

Meanwhile, in the case the voice information is input by the input unit 101, since actual vocalization lengths of phonetic values extracted by voice recognition may be different from general (or representative) vocalization lengths stored in the phonetic value information storing unit 102, the transition section allocating unit 105 corrects the transition section time information extracted from the transition section storing unit 102 suitably for actual vocalization lengths of two adjacent phonetic values adjacent before and after the transition section. In other words, in the case actual vocalization lengths of two adjacent phonetic values are longer than general vocalization lengths, the transition section allocating unit 105 assigns a long transition section between two phonetic values, and in the case actual vocalization lengths are shorter than general vocalization lengths, the transition section allocating unit 105 assigns a short transition section.

The phonetic value context information storing unit 106 stores a detail phonetic value obtained by subdividing each phonetic value into at least one phonetic value by considering a preceding and/or following phonetic value (or, context) of the corresponding phonetic value. In other words, for each phonetic value, the phonetic value context information storing unit 106 stores a detail phonetic value obtained by subdividing each phonetic value into at least one actual sound value by considering a preceding or following phonetic value (or, context) of the corresponding phonetic value.

Table 2 below shows a detail phonetic value stored in the phonetic value context information storing unit 106 in consideration of a preceding or following context according to an embodiment of the present disclosure.

TABLE 2

| Phonetic | Preceding | Following | Detail phonetic |
|---|---|---|---|
| value | phonetic value | phonetic value | value |
| b | N/A | r | b/_r |
| b | e | r | b/e_r |
| r | b | e | r/b_e |
| r | c | d | r/c_d |
| e | t | N/A | e/t_ |
| e | r | d | e/r_d |
| d | e | N/A | d/e_ |

. . .

Referring to Table 2, in the case another phonetic value is not present before a phonetic value /b/ and a phonetic value /r/ is present after the phonetic value /b/, the phonetic value context information storing unit 106 stores ‘b_r’ as a detail phonetic value of the phonetic value /b/, and in the case a phonetic value /e/ is present before the phonetic value /b/ and a phonetic value /r/ is present after the phonetic value /b/, the phonetic value context information storing unit 106 stores ‘b/e_r’ as a detail phonetic value of the phonetic value /b/.

The phonetic value context applying unit 107 reconstitutes the phonetic value constitution information by including the detail phonetic value list in the phonetic value constitution information to which a transition section is assigned, with reference to the detail phonetic value stored in the phonetic value context information storing unit 106. In detail, the phonetic value context applying unit 107 checks a phonetic value adjacent to each phonetic value in the phonetic value constitution information to which a transition section is assigned and extracts a detail phonetic value corresponding to each phonetic value included in the phonetic value constitution information from the phonetic value context information storing unit 106 based thereon to generate a detail phonetic value list corresponding to the phonetic value list of the phonetic value constitution information. In addition, the phonetic value context applying unit 107 reconstitutes the phonetic value constitution information to which a transition section is assigned by including the detail phonetic value list in the phonetic value constitution information.

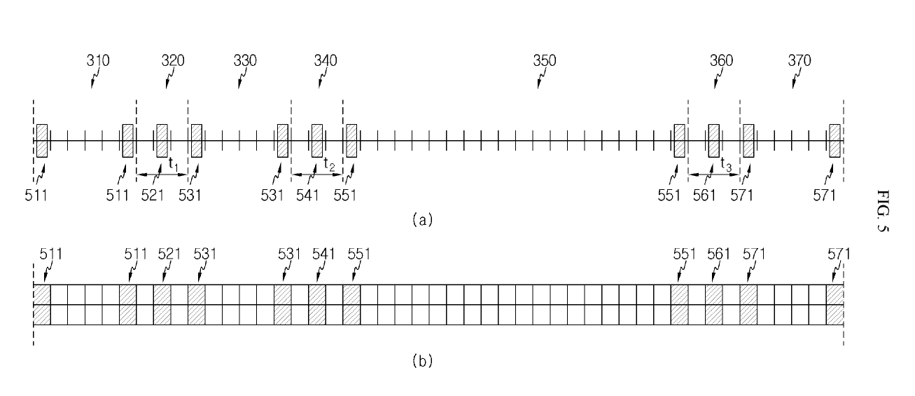

FIG. 4 is a diagram showing phonetic value constitution information including detail phonetic values according to an embodiment of the present disclosure.

Referring to FIG. 4, the phonetic value context applying unit 107 checks a phonetic value adjacent to each phonetic value (namely, /b/, /e/, /d/) in the phonetic value constitution information (namely, /bred/) to which a transition section is assigned. In other words, the phonetic value context applying unit 107 checks that a phonetic value following the phonetic value /b/ is /r/, phonetic values arranged before and after the phonetic value /r/ are /b/, /e/, phonetic values arranged before and after the phonetic value /e/ are /r/, /d/, and a phonetic value preceding the phonetic value /d/ is /e/, in the phonetic value constitution information (namely, /bred/). In addition, the phonetic value context applying unit 107 extracts a detail phonetic value corresponding to each phonetic value in the phonetic value context information storing unit 106, based on the checked adjacent phonetic value. In other words, the phonetic value context applying unit 107 extracts ‘b/_r’ as a detail phonetic value of the phonetic value /b/, ‘r/b_e’ as a detail phonetic value of the phonetic value /r/, ‘e/r_d’ as a detail phonetic value of the phonetic value /e/ and ‘d/e_’ as a detail phonetic value of the phonetic value /d/ from the phonetic value context information storing unit 106, and generates a detail phonetic value list ‘b/_r, r/b_e, e/r_d, d/e_’ based thereon. Further, the phonetic value context applying unit 107 reconstitutes the phonetic value constitution information to which the transition section is assigned by including the generated detail phonetic value list in the phonetic value constitution information.

Meanwhile, the phonetic value context information storing unit 106 may store a further-subdivided general or representative vocalization length of each detail phonetic value, and in this case, the phonetic value context applying unit 107 may apply the subdivided vocalization length instead of the vocalization length assigned by the phonetic value constitution information generating unit 103. However, preferably, in the case where the vocalization length assigned by the phonetic value constitution information generating unit 103 is an actual vocalization length extracted by voice recognition, the vocalization length is applied as it is.

In addition, the phonetic value context information storing unit 106 may store detail phonetic values obtained by subdividing a phonetic value by considering only the following phonetic value, and in this case, the phonetic value context applying unit 107 detects and applies the detail phonetic value of each phonetic value from the phonetic value context information storing unit 106 by considering only a following phonetic value in the phonetic value constitution information.

The pronunciation pattern information storing unit 108 stores pronunciation pattern information corresponding to the detail phonetic value and also stores pronunciation pattern information of each transition section. Here, the pronunciation pattern information relates to the shape of an articulator such as the lips, the tongue, the nose, the uvula, the palate, the teeth and the gum, when a specific detail phonetic value is vocalized. In addition, the pronunciation pattern information of a transition section means, when a first detail phonetic value and a second detail phonetic value are pronounced in succession, information representing the changing pattern of an articulator exhibited between both pronunciations. In addition, the pronunciation pattern information storing unit 108 may store two or more kinds of pronunciation pattern information as the pronunciation pattern information of a specific transition section and may also not store pronunciation pattern information. Moreover, the pronunciation pattern information storing unit 108 stores a representative image of an articulator or a vector which will be a basis when generating the representative image, as the pronunciation pattern information.

The pronunciation pattern detecting unit 109 detects pronunciation pattern information corresponding to a detail phonetic value and a transition section, included in the phonetic value constitution information, from the pronunciation pattern information storing unit 108. At this time, the pronunciation pattern detecting unit 109 detects pronunciation pattern information of each transition section from the pronunciation pattern information storing unit 108 with reference to an adjacent detail phonetic value in the phonetic value constitution information reconstituted by the phonetic value context applying unit 107. Moreover, the pronunciation pattern detecting unit 109 transmits the detected pronunciation pattern information and the phonetic value constitution information to the animation generating unit 110. In addition, the pronunciation pattern detecting unit 109 may extract two or more kinds of pronunciation pattern information for a specific transition section included in the phonetic value constitution information from the pronunciation pattern information storing unit 108 and transmit them to the animation generating unit 110.

Meanwhile, the pronunciation pattern information of a transition section included in the phonetic value constitution information may not be detected from the pronunciation pattern information storing unit 108. In other words, the pronunciation pattern information of a specific transition section may not be stored in the pronunciation pattern information storing unit 108, and accordingly the pronunciation pattern detecting unit 109 may not detect the pronunciation pattern information corresponding to the transition section from the pronunciation pattern information storing unit 108. For example, even though pronunciation pattern information is not separately assigned to the transition section between a phonetic value /t/ and a phonetic value /s/, the pronunciation pattern information of the transition section may be generated similar to that of a native speaker by performing interpolation between the pronunciation pattern information corresponding to the phonetic value /t/ and the pronunciation pattern information corresponding to the phonetic value /s/.

The animation generating unit 110 assigns the pronunciation pattern information as key frames based on the vocalization length of each detail phonetic value and the transition section, and then performs interpolation between the assigned key frames by means of an animation interpolating technique to generate a vocal organ animation corresponding to the character information. In detail, the animation generating unit 110 assigns the pronunciation pattern information corresponding to each detail phonetic value as key frames of a vocalization start point and a vocalization end point corresponding to the vocalization length of the corresponding detail phonetic value. Moreover, the animation generating unit 110 performs interpolation between the two key frames assigned based on the vocalization length start and end points of the detail phonetic value to fill a vacant general frame between the key frames.

In addition, the animation generating unit 110 assigns the pronunciation pattern information of each transition section to a middle point of the transition section as a key frame, performs interpolation between the assigned key frame of the transition section (namely, transition section pronunciation pattern information) and a key frame assigned before the transition section key frame, and also performs interpolation between the key frame of the transition section and a key frame assigned after the transition section key frame, thereby filling a vacant general frame in the corresponding transition section.

Preferably, in the case two or more kinds of pronunciation pattern information are present for a specific transition section, the animation generating unit 110 assigns the pronunciation pattern information to the transition section so that two or more kinds of pronunciation pattern information are spaced at regular time intervals, and performs interpolation between a corresponding key frame assigned to the transition section and an adjacent key frame to fill a vacant general frame in the corresponding transition section. Meanwhile, in the case the pronunciation pattern information of a specific transition section is not detected by the pronunciation pattern detecting unit 109, the animation generating unit 110 performs interpolation between pronunciation pattern information of two detail phonetic values adjacent to the transition section without assigning the pronunciation pattern information of the corresponding transition section, thereby generating a general frame to be assigned to the transition section.

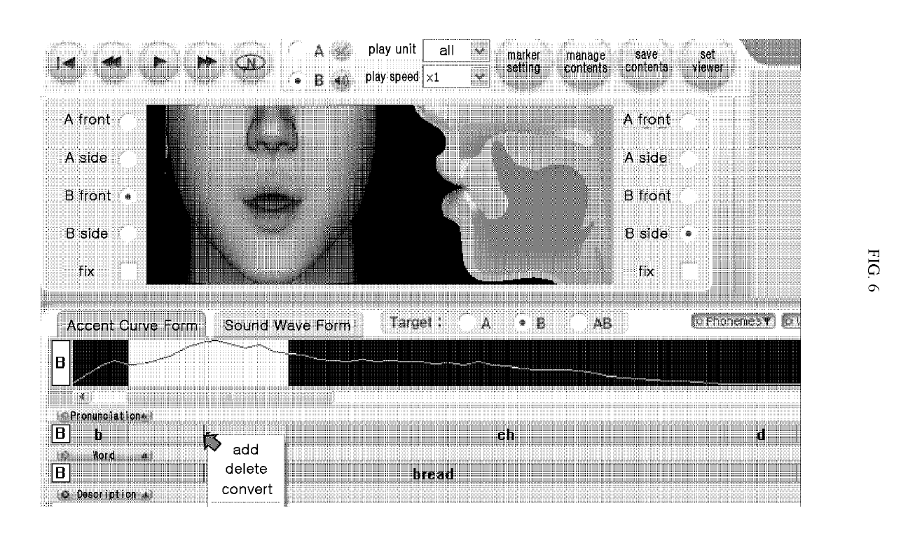

FIG. 5 is a diagram showing a vocal organ animation to which a key frame and a general frame are assigned according to an embodiment of the present disclosure.

Referring to FIG. 5, the animation generating unit 110 assigns pronunciation pattern information 511, 531, 551, 571 corresponding to each detail phonetic value included in the phonetic value constitution information to start and end points of a vocalization length of the corresponding detail phonetic value as key frames. Moreover, the animation generating unit 110 assigns pronunciation pattern information 521, 541, 561 corresponding to each transition section to a middle point of the corresponding transition section as a key frame. At this time, in the case two or more kinds of pronunciation pattern information are present for a specific transition section, the animation generating unit 110 assigns the pronunciation pattern information to the corresponding transition section so that two or more kinds of pronunciation pattern information are spaced at regular time intervals.

If the key frames are assigned completely, the animation generating unit 110 fills a vacant general frame between adjacent key frames by performing interpolation between the key frames as shown in FIG. 5b, thereby completely making a single vocal organ animation where frames are arranged in succession. The frame marked with oblique lines is a key frame, and the frame not marked with oblique lines is a general frame generated by the animation interpolating technique.

Meanwhile, in the case pronunciation pattern information of a specific transition section is not detected by the pronunciation pattern detecting unit 109, the animation generating unit 110 performs interpolation between pronunciation pattern information of two detail phonetic values adjacent to the transition section without assigning the pronunciation pattern information of the corresponding transition section, thereby generating a general frame to be assigned to the transition section. In the case the pronunciation pattern information corresponding to reference symbol 541 in FIG. 5b is not detected by the pronunciation pattern detecting unit 109, the animation generating unit generates a general frame to be assigned to the transition section 340 by performing interpolation between the pronunciation pattern information 532, 551 of two detail phonetic values adjacent to the corresponding transition section 340.

In order to display a changing pattern of an articulator located in the mouth such as the tongue, the oral cavity, the uvula (palate) or the like, the animation generating unit 110 generates an animation for a side section of the face as shown in FIG. 6 and additionally generates an animation for a front side of the face in order to display a changing pattern of the lips of a native speaker. Meanwhile, in the case voice information is input by the input unit 101, the animation generating unit 110 generates an animation synchronized with the voice information. In other words, the animation generating unit 110 generates a vocal organ animation so that the entire vocalization length of the vocal organ animation is synchronized identical to the vocalization length of the voice information.

As shown in FIG. 6, the display unit 111 outputs at least one of a phonetic value list representing a sound value of character information, a vocalization length of each phonetic value, a transition section assigned between phonetic values, a detail phonetic value list included in the phonetic value constitution information, a vocalization length of each detail phonetic value, and a transition section assigned between detail phonetic values to a display means such as a liquid crystal display together with a vocal organ animation. At this time, the display unit 111 may output voice information of a native speaker corresponding to the character information through a speaker.

The animation coordinating unit 112 provides an interface which allows a user to reset a phonetic value list representing a sound value of character information, a vocalization length of each phonetic value, a transition section assigned between phonetic values, a detail phonetic value list included in the phonetic value constitution information, a vocalization length of each detail phonetic value, a transition section assigned between detail phonetic values or pronunciation pattern information, which has been input. In other words, the animation coordinating unit 112 provides an interface to a user to coordinate the vocal organ animation, and receives at least one kind of reset information among an individual phonetic value included in the phonetic value list, a vocalization length of each phonetic value, a transition section assigned between phonetic values, a detail phonetic value, a vocalization length of each detail phonetic value, a transition section assigned between detail phonetic values, and pronunciation pattern information, through the input unit 101 from the user. In other words, the user resets an individual phonetic value included in the phonetic value list, a vocalization length of a specific phonetic value, a transition section assigned between phonetic values, a detail phonetic value included in the phonetic value constitution information, a vocalization length of each detail phonetic value, a transition section assigned between detail phonetic values or pronunciation pattern information by using an input means such as a mouse and a keyboard.

In this case, the animation coordinating unit 112 checks the reset information input by the user, and selectively transmits the reset information to the phonetic value constitution information generating unit 103, the transition section allocating unit 105, the phonetic value context applying unit 107 or the pronunciation pattern detecting unit 109.

In detail, if the reset information about an individual phonetic value of a sound value of the character information or the reset information about a vocalization length of the phonetic value is received, the animation coordinating unit 112 transmits the reset information to the phonetic value constitution information generating unit 103, and the phonetic value constitution information generating unit 103 regenerates phonetic value constitution information by reflecting the reset information. Moreover, the transition section allocating unit 105 checks an adjacent phonetic value in the phonetic value constitution information, and assigns a transition section again in the phonetic value constitution information based thereon. Moreover, the phonetic value context applying unit 107 reconstitutes a detail phonetic value, a vocalization length of each detail phonetic value, and phonetic value constitution information where a transition section is assigned between detail phonetic values, based on the phonetic value constitution information to which the transition section is reassigned, and the pronunciation pattern detecting unit 109 extracts pronunciation pattern information corresponding to each detail phonetic value and each transition section again based on the reconstituted phonetic value constitution information. Further, the animation generating unit 110 regenerates a vocal organ animation based on the re-extracted pronunciation pattern information and outputs the vocal organ animation to the display unit 111.

In other cases, if the reset information of a transition section assigned between phonetic values from a user is received, the animation coordinating unit 112 transmits the reset information to the transition section allocating unit 105, and the transition section allocating unit 105 assigns a transition section between adjacent phonetic values again so that the reset information is reflected. Moreover, the phonetic value context applying unit 107 reconstitutes a detail phonetic value, a vocalization length of each detail phonetic value, and phonetic value constitution information where a transition section assigned between detail phonetic values, based on the phonetic value constitution information to which the transition section is assigned again, and the pronunciation pattern detecting unit 109 extracts pronunciation pattern information corresponding to each detail phonetic value and each transition section again based on the reconstituted phonetic value constitution information. Further, the animation generating unit 110 regenerates a vocal organ animation based on the re-extracted pronunciation pattern information and outputs the vocal organ animation to the display unit 111.

In addition, if the reset information for correcting the detail phonetic value, adjusting the vocalization length of the detail phonetic value, adjusting the transition section or the like is received, the animation coordinating unit 112 transmits the reset information to the phonetic value context applying unit 107, and the phonetic value context applying unit 107 reconstitutes phonetic value constitution information once more based on the reset information. Similarly, the pronunciation pattern detecting unit 109 extracts pronunciation pattern information corresponding to each detail phonetic value and each transition section again based on the reconstituted phonetic value constitution information, and the animation generating unit 110 regenerates a vocal organ animation based on the re-extracted pronunciation pattern information and outputs the vocal organ animation to the display unit 111.

Meanwhile, if any one kind of change information in the pronunciation pattern information is received, the animation coordinating unit 112 transmits the changed pronunciation pattern information to the pronunciation pattern detecting unit 109, and the pronunciation pattern detecting unit 109 changes the corresponding pronunciation pattern information into the transmitted pronunciation pattern information. Moreover, the animation generating unit 110 regenerates a vocal organ animation based on the changed pronunciation pattern information and outputs the vocal organ animation to the display unit 111.

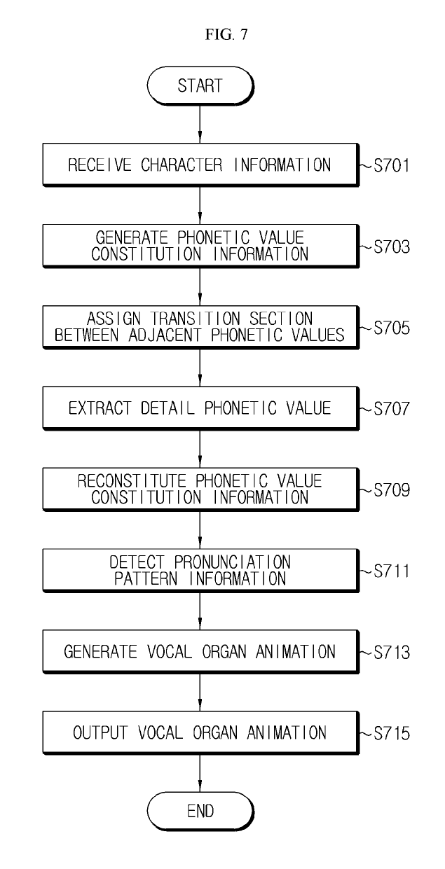

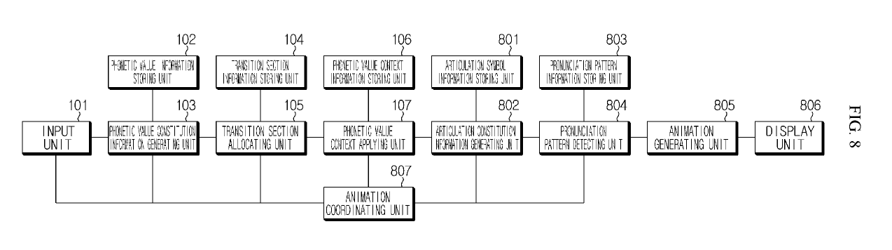

FIG. 7 is a flowchart for illustrating a method for generating a vocal organ animation corresponding to the phonetic value constitution information by the apparatus for generating a vocal organ animation according to an embodiment of the present disclosure.

Referring to FIG. 7, the input unit 101 receives character information including a phoneme, a syllable, a word, a phrase or a sentence from a user (S701). Selectively, the input unit 101 receives voice information instead of the character information or receives both the character information and the voice information.

Then, the phonetic value constitution information generating unit 103 checks words arranged in the character information. In addition, the phonetic value constitution information generating unit 103 extracts phonetic value information of each word and a vocalization length of each phonetic value included in the phonetic value information from the phonetic value information storing unit 102. After that, the phonetic value constitution information generating unit 103 generates phonetic value constitution information corresponding to the character information based on the extracted phonetic value information and the vocalization length of each phonetic value (S703, see FIG. 2). The phonetic value constitution information includes a phonetic value list to which a vocalization length is allocated. Meanwhile, in the case voice information is input by the input unit 101, the phonetic value constitution information generating unit 103 analyzes and extracts phonetic values of the voice information and the vocalization length of each phonetic value by performing voice recognition to the received voice information and generates phonetic value constitution information corresponding to the voice information based thereon.

After that, the transition section allocating unit 105 assigns a transition section between adjacent phonetic values of the phonetic value constitution information based on the transition section information of every adjacent phonetic values of the transition section information storing unit 104 (S705, see FIG. 3). At this time, the transition section allocating unit 105 assigns a part of the vocalization length of the phonetic value, to which the transition section is assigned, to a vocalization length of the transition section.

If a transition section is assigned to the phonetic value constitution information as described above, the phonetic value context applying unit 107 checks a phonetic value adjacent to each phonetic value in the phonetic value constitution information to which the transition section is assigned, and extracts a detail phonetic value corresponding to each phonetic value from the phonetic value context information storing unit 106 based thereon to generate a detail phonetic value list corresponding to the phonetic value list (S707). Subsequently, the phonetic value context applying unit 107 reconstitutes phonetic value constitution information by including the detail phonetic value list in the phonetic value constitution information (S709).

The pronunciation pattern detecting unit 109 detects pronunciation pattern information corresponding to the detail phonetic value in the reconstituted phonetic value constitution information from the pronunciation pattern information storing unit 108, and also detects pronunciation pattern information corresponding to the transition section from the pronunciation pattern information storing unit 108 (S711). At this time, the pronunciation pattern detecting unit 109 detects pronunciation pattern information of each transition section from the pronunciation pattern information storing unit 108 with reference to adjacent detail phonetic values in the phonetic value constitution information. Moreover, the pronunciation pattern detecting unit 109 transmits the detected pronunciation pattern information and the phonetic value constitution information to the animation generating unit 110.

After that, the animation generating unit 110 assigns the pronunciation pattern information corresponding to each detail phonetic value included in the phonetic value constitution information as start and end point key frames of the corresponding detail phonetic value, and also assigns the pronunciation pattern information corresponding to each transition section as key frames of the transition section. In other words, the animation generating unit 110 assigns key frames so that the pronunciation pattern information of each detail phonetic value is played as much as the corresponding vocalization length and the pronunciation pattern information of the transition section is displayed only at a specific point in the corresponding transition section. Subsequently, the animation generating unit 110 fills a vacant general frame between the key frames (namely, pronunciation pattern information) by means of an animation interpolating technique, thereby generating a single complete vocal organ animation (S713). At this time, in the case pronunciation pattern information corresponding to a specific transition section is not present, the animation generating unit 110 performs interpolation to pronunciation pattern information adjacent to the transition section to generate a general frame corresponding to the transition section. Meanwhile, in the case two or more kinds of pronunciation pattern information are present for a specific transition section, the animation generating unit 110 assigns the pronunciation pattern information to the transition section so that two or more kinds of pronunciation pattern information are spaced at regular time intervals, and performs interpolation between the corresponding key frame assigned to the transition section and an adjacent key frame to fill a vacant general frame in the corresponding transition section.

If the vocal organ animation is generated as described above, the display unit 111 displays the phonetic value list representing a sound value of character information input by the input unit 101, the detail phonetic value and the transition section included in the phonetic value constitution information, and the vocal organ animation to a display means such as a liquid crystal display (S715). At this time, the display unit 111 may output voice information of a native speaker corresponding to the character information or voice information of the user input by the input unit 101 through a speaker.

Meanwhile, the apparatus for generating a vocal organ animation may receive reset information about the vocal organ animation, displayed by the display unit 111, from the user. In other words, the animation coordinating unit 112 of the apparatus for generating a vocal organ animation receives at least one kind of reset information among an individual phonetic value included in the phonetic value list, a vocalization length of each phonetic value, a transition section assigned between phonetic values, a detail phonetic value list included in the phonetic value constitution information, a vocalization length of each detail phonetic value, a transition section assigned between detail phonetic values, and pronunciation pattern information through the input unit 101 from the user. In this case, the animation coordinating unit 112 checks the reset information input by the user and selectively transmits the reset information to the phonetic value constitution information generating unit 103, the transition section allocating unit 105, the phonetic value context applying unit 107 or the pronunciation pattern detecting unit 109. Accordingly, the phonetic value constitution information generating unit 103 regenerates phonetic value constitution information based on the reset information or the transition section allocating unit 105 assigns a transition section between adjacent phonetic values again. In other cases, the phonetic value context applying unit 107 reconstitutes phonetic value constitution information based on the reset information once more, or the pronunciation pattern detecting unit 109 changes the pronunciation pattern information extracted in Step S711 into the reset pronunciation pattern information.

In other words, if reset information is received from the user through the animation coordinating unit 112, the apparatus for generating a vocal organ animation executes Steps S703 to S715 entirely or a part thereof selectively again according to the reset information.

Hereinafter, an apparatus and method for generating a vocal organ animation according to another embodiment of the present disclosure will be described.

FIG. 8 is a diagram showing an apparatus for generating a vocal organ animation according to another embodiment of the present disclosure.

Hereinafter, in FIG. 8, the same reference symbol as in FIG. 1 gives the same function as in FIG. 1, and so it is not described in detail here.

As shown in FIG. 8, the apparatus for generating a vocal organ animation according to another embodiment of the present disclosure includes an input unit 101, a phonetic value information storing unit 102, a phonetic value constitution information generating unit 103, a transition section information storing unit 104, a transition section allocating unit 105, a phonetic value context information storing unit 106, a phonetic value context applying unit 107, an articulation symbol information storing unit 801, an articulation constitution information generating unit 802, a pronunciation pattern information storing unit 803, a pronunciation pattern detecting unit 804, an animation generating unit 805, a display unit 806 and an animation coordinating unit 807.

The articulation symbol information storing unit 801 stores an articulation symbol corresponding to the detail phonetic value, for each articulator. The articulation symbol expresses the state of each articulator with a recognizable symbol when the detail phonetic value is vocalized by the articulator, and the articulation symbol information storing unit 801 stores an articulation symbol corresponding to each phonetic value with respect to each articulator. Preferably, the articulation symbol information storing unit 801 stores the articulation symbol of each articulator which includes the degree of vocalization involvement by considering a preceding or following phonetic value. For example, in the case phonetic values /b/ and /r/ are vocalized in succession, the lips among articulators are generally involved in vocalization of the phonetic value /b/, and the tongue is generally involved in vocalization of the phonetic value /r/. Therefore, in the case phonetic values /b/ and /r/ are vocalized in succession, while the lips serving as an articulator are being involved in vocalization of the phonetic value /b/, the tongue serving as an articulator is involved in vocalization of the phonetic value /r/ in advance. The articulation symbol information storing unit 801 stores the articulation symbol including the degree of vocalization involvement by considering such a preceding or following phonetic value.

Further, in case of distinguishing two phonetic values, if a specific articulator has a remarkably important role and the other articulators have insignificant roles and maintain similar shapes, by reflecting the tendency that persons keep articulators having insignificant roles and maintaining similar shapes in a certain fixed shape when vocalizing two phonetic values in succession according to the economy in pronunciation, the articulation symbol information storing unit 801 changes the articulation symbol of an articulator having an insufficient role and maintaining a similar shape into an articulation symbol of a following phonetic value when two phonetic values are vocalized in succession and stores the same. For example, in the case a phonetic value /f/ follows a phonetic value /m/, the uvula (the palate) performs a critical role for distinguishing the phonetic values /m/ and /f/ and the lip portion performs a relatively insufficient role and maintains its shape similarly. Therefore, when vocalizing the phonetic value /m/, persons tend to keep the lip portion in the shape when vocalizing a phonetic value /f/. Therefore, for the same phonetic value, the articulation symbol information storing unit 801 stores different articulation symbols for each articulator according to a preceding or following phonetic value.

If the phonetic value constitution information is reconstituted by the phonetic value context applying unit 107, the articulation constitution information generating unit 802 extracts an articulation symbol corresponding to each detail phonetic value from the articulation symbol information storing unit 801, for each articulator. Further, the articulation constitution information generating unit 802 checks a vocalization length of each detail phonetic value included in the phonetic value constitution information, and allocates a vocalization length of each articulation symbol to correspond to the vocalization length of the corresponding detail phonetic value. Meanwhile, if the degree of vocalization involvement for each articulation symbol is stored in the form of vocalization length in the articulation symbol information storing unit 801, the articulation constitution information generating unit 802 extracts a vocalization length of each articulation symbol from the articulation symbol information storing unit 801, and allocates a vocalization length of the corresponding articulation symbol based thereon.

In addition, the articulation constitution information generating unit 802 generates articulation constitution information of the corresponding articulator by combining each articulation symbol and the vocalization length of each articulation symbol and at this time allocates a transition section in the articulation constitution information to correspond to the transition section included in the phonetic value constitution information. Meanwhile, the articulation constitution information generating unit 802 may reset the vocalization length of each articulation symbol or the vocalization length of each transition section based on the degree of vocalization involvement of each articulation symbol included in the articulation constitution information.

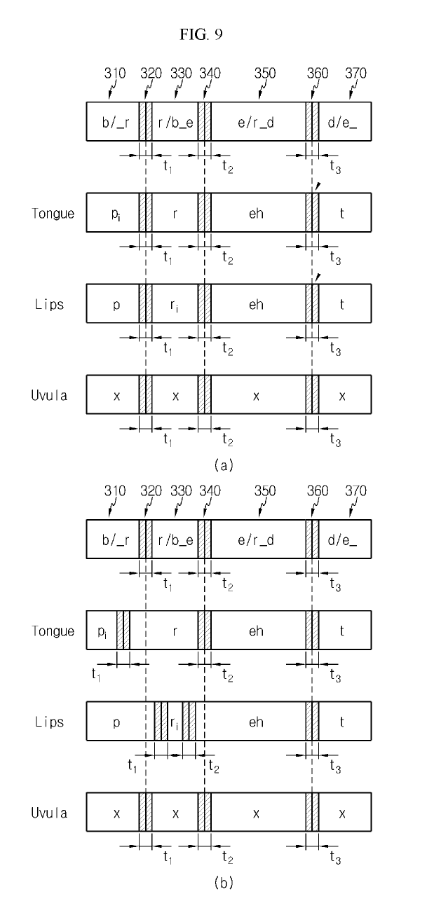

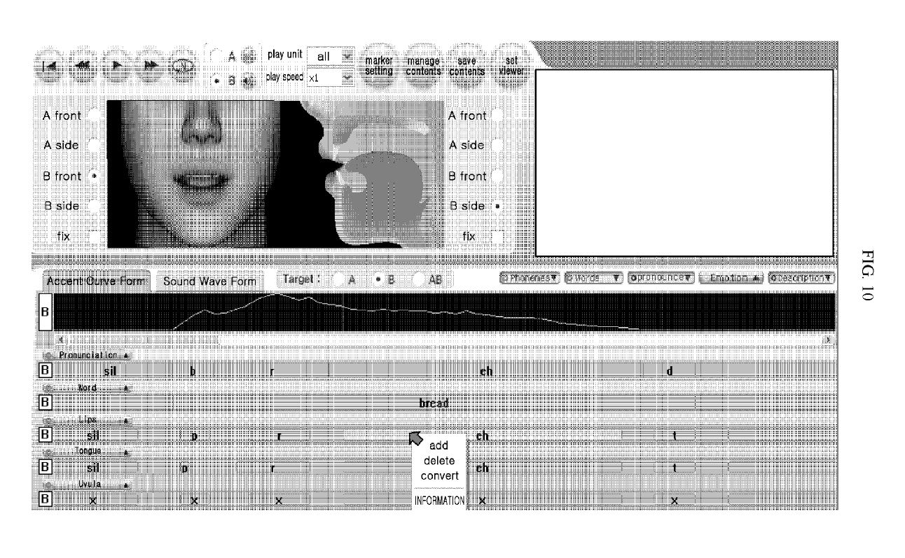

FIG. 9 is a diagram showing articulation constitution information of each articulator according to another embodiment of the present disclosure.

Referring to FIG. 9a, the articulation constitution information generating unit 802 extracts an articulation symbol corresponding to each detail phonetic value (namely, ‘b/_r’, ‘r/b_e’, ‘e/r_d’, ‘d/e_’) included in the phonetic value constitution information from the phonetic value context information storing unit 106, for each articulator. In other words, the phonetic value context applying unit 107 extracts /pᵢ/, /r/, /eh/, /t/ as articulation symbols of the tongue, /p/, /rᵢ/, /eh/, /t/ as articulation symbols of the lips, and /X/, /X/, /X/, /X/ as articulation symbols of the uvula, respectively, to correspond to detail phonetic values ‘b/_r’ ‘r/b_e’, ‘e/r_d, ‘d/e_’. Here, ‘X’ is information representing that the articulator is not involved in vocalization of the corresponding detail phonetic value, and in addition, in ‘pᵢ’ [symbol] ‘rᵢ’, the subscript ‘i’ is information representing that the articulation symbols /p/ and in are weakly involved in vocalization of the corresponding articulator. In detail, in the phonetic value constitution information including detail phonetic values ‘b/_r’, ‘r/b_e’, ‘e/r_d’ and ‘d/e_’, /pᵢreht/ which is articulation constitution information of the tongue represents that the tongue minutely acts in the mouth when pronouncing the detail phonetic value ‘b/_r’, and /XXXX/ which is articulation constitution information of the uvula represents that the uvula is entirely closed when the detail phonetic values included in the phonetic value constitution information are pronounced in succession. In addition, in /prᵢeht/ which is articulation constitution information of the lips, ‘rᵢ’ represents that the lips minutely act in order to pronounce the detail phonetic value ‘r/b_e’.

The articulation constitution information generating unit 802 generates /pᵢreht/ which is articulation constitution information of the tongue, /prᵢeht/ which is articulation constitution information of the lips, and /XXXX/ which is articulation constitution information of the uvula, respectively, based on the extracted articulation symbol. At this time, the articulation constitution information generating unit 802 assigns a vocalization length of each articulation symbol to correspond to the vocalization length of each detail phonetic value in the phonetic value constitution information, and assigns a transition section between adjacent articulation symbols to be identical to the transition section assigned to the phonetic value constitution information.

Meanwhile, the articulation constitution information generating unit 802 may reset a vocalization length of the articulation symbol or a vocalization length of the transition section included in the articulation constitution information, based on the degree of vocalization involvement of each articulation symbol.

Referring to FIG. 9b, the articulation constitution information generating unit 802 checks in the articulation constitution information /pᵢreht/ of the tongue that the tongue is minutely involved in pronunciation of the detail phonetic value ‘b/_r’, and accordingly, in order to reflect the tendency that the tongue prepares pronunciation of the detail phonetic value ‘b/_r’ at the point that the detail phonetic value ‘b/_r’ is pronounced by another articulator, the articulation constitution information generating unit 802 assigns a part of the vocalization length of the articulation symbol /pᵢ/ corresponding to the detail phonetic value ‘b/_r’ as a length with which the articulation symbol /r/ is vocalized. In other words, the articulation constitution information generating unit 802 reduces a vocalization time for the articulation symbol /pᵢ/ which is less involved in pronunciation, and adds the reduced time of /pᵢ/ to the vocalization length of /r/ which is an adjacent articulation symbol. In addition, since the lips is substantially not involved in pronunciation of the detail phonetic value ‘r/b_e’, the articulation constitution information generating unit 802 reduces the vocalization length of the articulation symbol /rᵢ/ in the articulation constitution information (namely, /prᵢeht/) of the lips and lengthens the vocalization length of adjacent articulation symbols (namely, /p/ and /eh/) as much as the reduced vocalization length.

Meanwhile, the articulation symbol information storing unit 801 may not store the degree of vocalization involvement of each articulation symbol. In this case, the articulation constitution information generating unit 802 may store information relating to the degree of vocalization involvement of each articulation symbol, and then check the degree of vocalization involvement of each articulation symbol based on the stored information to reset a vocalization length of each articulation symbol and a transition section included in the articulation constitution information for each articulator.

The pronunciation pattern information storing unit 803 stores pronunciation pattern information corresponding to the articulation symbol for each articulator, and also stores pronunciation pattern information of the transition section according to an adjacent articulation symbol for each articulator.

The pronunciation pattern detecting unit 804 detects pronunciation pattern information corresponding to the articulation symbol and the transition section included in the articulation constitution information from the pronunciation pattern information storing unit 803, for each articulator. At this time, the pronunciation pattern detecting unit 804 detects pronunciation pattern information of each transition section from the pronunciation pattern information storing unit 803 for each articulator, based on an adjacent articulation symbol in the articulation constitution information generated by the articulation constitution information generating unit 802. Moreover, the pronunciation pattern detecting unit 804 transmits the detected pronunciation pattern information and the detected articulation constitution information of each articulator to the animation generating unit 805.

The animation generating unit 805 generates an animation of each articulator based on the articulation constitution information and the pronunciation pattern information transmitted from the pronunciation pattern detecting unit 804, and composes the generated animations to generate a single vocal organ animation corresponding to the character information received by the input unit 101. In detail, the animation generating unit 805 assigns the pronunciation pattern information corresponding to each articulation symbol as key frames to correspond to start and end points of the vocalization length of the corresponding articulation symbol, respectively, and also assigns the pronunciation pattern information corresponding to each transition section as a key frame of the corresponding transition section. In other words, the animation generating unit 805 assigns the pronunciation pattern information as key frames to correspond to a vocalization start point and a vocalization end point of the articulation symbol so that the pronunciation pattern information of each articulation symbol is played as much as the corresponding vocalization length, and assigns the pronunciation pattern information of the transition section as a key frame so as to be displayed at a specific point in the corresponding transition section. Moreover, the animation generating unit 805 generates an animation of each articulator by filling a vacant general frame between key frames (namely, pronunciation pattern information) by means of an animation interpolating technique, and composes the animations of articulators into a single vocal organ animation.

In other words, the animation generating unit 805 assigns the pronunciation pattern information of each articulation symbol as key frames of a vocalization start point and a vocalization end point corresponding to the vocalization length of the corresponding articulation symbol. Moreover, the animation generating unit 805 performs interpolation between two assigned key frames based on the start and end points of the vocalization length of the articulation symbol to fill a vacant general frame between two key frames. In addition, the animation generating unit 805 assigns the pronunciation pattern information of each transition section assigned between articulation symbols as a key frame in a middle point of the corresponding transition section, performs interpolation between the assigned key frame (namely, transition section pronunciation pattern information) of the transition section and a key frame assigned before the transition section key frame, and also performs interpolation between the key frame of the transition section and a key frame assigned after the transition section key frame, thereby filling a vacant general frame in the corresponding transition section. Preferably, in the case two or more kinds of pronunciation pattern information are present for a specific transition section assigned between articulation symbols, the animation generating unit 805 assigns the pronunciation pattern information to the transition section so that two or more kinds of pronunciation pattern information are spaced at regular time intervals, and performs interpolation between the corresponding key frame assigned to the transition section and an adjacent key frame to fill a vacant general frame in the corresponding transition section. Meanwhile, in the case pronunciation pattern information of a specific transition section assigned between articulation symbols is not detected by the pronunciation pattern detecting unit 804, the animation generating unit 805 performs interpolation between the pronunciation pattern information of two articulation symbols adjacent to the transition section without assigning the pronunciation pattern information of the corresponding transition section, thereby generating a general frame to be assigned to the transition section.

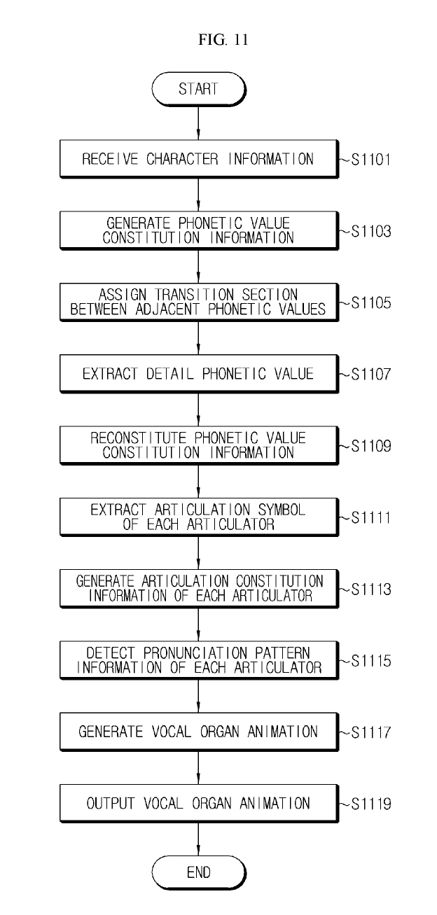

As shown in FIG. 10, the display unit 806 displays a phonetic value list representing a sound value of character information, which has been input, a vocalization length of each phonetic value, a transition section assigned between phonetic values, a detail phonetic value included in the phonetic value constitution information, a vocalization length of each detail phonetic value, a transition section assigned between detail phonetic values, an articulation symbol included in the articulation constitution information, a vocalization length of each articulation symbol, a transition section assigned between articulation symbols and vocal organ animation to a display means such as a liquid crystal display.

The animation coordinating unit 807 provides an interface which allows a user to reset an individual phonetic value included in the phonetic value list, a vocalization length of each phonetic value, a transition section assigned between phonetic values, a detail phonetic value included in the phonetic value constitution information, a vocalization length of each detail phonetic value, a transition section assigned between detail phonetic values, an articulation symbol included in the articulation constitution information, a vocalization length of each articulation symbol, a transition section assigned between articulation symbols or pronunciation pattern information. In addition, if the reset information from the user is received, the animation coordinating unit 807 selectively transmits the reset information to the phonetic value constitution information generating unit 103, the transition section allocating unit 105, the phonetic value context applying unit 107, the articulation constitution information generating unit 802 or the pronunciation pattern detecting unit 804.

In detail, if reset information such as correction or deletion of an individual phonetic value of a sound value of the character information or reset information relating to a vocalization length of a phonetic value is received, the animation coordinating unit 807 transmits the reset information to the phonetic value constitution information generating unit 103, similar to the animation coordinating unit 112 illustrated with reference to FIG. 1, and if reset information relating to an adjacent transition section assigned between phonetic values is received, the animation coordinating unit 807 transmits the reset information to the transition section allocating unit 105. Accordingly, the phonetic value constitution information generating unit 103 or the transition section allocating unit 105 regenerates phonetic value constitution information or re-assigns a transition section between adjacent phonetic values based on the reset information. In other case, if reset information such as correction of a detail phonetic value, adjustment of a vocalization length of the detail phonetic value, adjustment of a transition section or the like is received from the user, similar to the animation coordinating unit 112 illustrated with reference to FIG. 1, the reset information is transmitted to the phonetic value context applying unit 107, and the phonetic value context applying unit 107 reconstitutes phonetic value constitution information once more based on the reset information.

In addition, if change information for at least one of the pronunciation pattern information of each articulator from the user is received, the animation coordinating unit 807 transmits the changed pronunciation pattern information to the pronunciation pattern detecting unit 804, and the pronunciation pattern detecting unit 804 changes the corresponding pronunciation pattern information into the transmitted pronunciation pattern information.

Meanwhile, if reset information relating to an articulation symbol included in the articulation constitution information, a vocalization length of each articulation symbol and a transition section assigned between adjacent articulation symbols is received, the animation coordinating unit 807 transmits the reset information to the articulation constitution information generating unit 802, and the articulation constitution information generating unit 802 regenerates articulation constitution information of each articulator based on the reset information. Further, the pronunciation pattern detecting unit 804 extracts each articulation symbol and pronunciation pattern information of each transition section allocated between articulation symbols again for each articulator, based on the regenerated articulation constitution information, and the animation generating unit 805 regenerates a vocal organ animation based on the re-extracted pronunciation pattern information.

FIG. 11 is a flowchart for illustrating a method for generating a vocal organ animation corresponding to the phonetic value constitution information by the apparatus for generating a vocal organ animation according to another embodiment of the present disclosure.

Hereinafter, in the description with reference to FIG. 11, the similar features as in FIG. 7 will be not described in detail but features different from those of FIG. 7 will be described in detail.

Referring to FIG. 11, the input unit 101 receives character information from a user (S1101). Then, the phonetic value constitution information generating unit 103 checks words arranged in the character information, and extracts phonetic value information of each word and a vocalization length of each phonetic value included in the phonetic value information from the phonetic value information storing unit 102. Next, the phonetic value constitution information generating unit 103 generates phonetic value constitution information corresponding to the character information based on the extracted phonetic value information and the extracted vocalization length of each phonetic value (S1103). Next, the transition section allocating unit 105 assigns a transition section between adjacent phonetic values of the phonetic value constitution information based on the transition section information of each adjacent phonetic value of the transition section information storing unit 104 (S1105).

Subsequently, the phonetic value context applying unit 107 checks a phonetic value adjacent to each phonetic value in the phonetic value constitution information to which the transition section is assigned, and extracts a detail phonetic value of each phonetic value from the phonetic value context information storing unit 106 based thereon to generate a detail phonetic value list corresponding to the phonetic value list of the phonetic value constitution information (S1107). Subsequently, the phonetic value context applying unit 107 reconstitutes phonetic value constitution information to which the transition section is assigned, by including the generated detail phonetic value list in the phonetic value constitution information (S1109).

Next, the articulation constitution information generating unit 802 extracts an articulation symbol corresponding to each detail phonetic value included in the phonetic value constitution information from the articulation symbol information storing unit 801, for each articulator (S1111). Subsequently, the articulation constitution information generating unit 802 checks a vocalization length of each detail phonetic value included in the phonetic value constitution information, and assigns a vocalization length of each articulation symbol to correspond to the vocalization length of each detail phonetic value. Next, the articulation constitution information generating unit 802 generates articulation constitution information of each articulator by combining each articulation symbol and a vocalization length of each articulation symbol, and allocates a transition section in the articulation constitution information to correspond to the transition section included in the phonetic value constitution information (S1113). At this time, the articulation constitution information generating unit 802 may check the degree of vocalization involvement of each articulation symbol and reset a vocalization length of each articulation symbol or a vocalization length of the transition section.

Next, the pronunciation pattern detecting unit 804 detects pronunciation pattern information corresponding to the articulation symbol and the transition section included in the articulation constitution information from the pronunciation pattern information storing unit 803, for each articulator (S1115). At this time, the pronunciation pattern detecting unit 804 detects pronunciation pattern information of each transition section from the pronunciation pattern information storing unit 803 for each articulator with reference to an adjacent articulation symbol in the articulation constitution information generated by the articulation constitution information generating unit 802. If the pronunciation pattern information is completely detected, the pronunciation pattern detecting unit 804 transmits the detected pronunciation pattern information and the articulation constitution information of each articulator to the animation generating unit 805.

After that, the animation generating unit 805 assigns the pronunciation pattern information corresponding to each articulation symbol as key frames to correspond to start and end points of a vocalization length of the corresponding articulation symbol, and also assigns the pronunciation pattern information corresponding to each transition section as a key frame at a specific point in the corresponding transition section. In other words, the animation generating unit 805 assigns the pronunciation pattern information as key frames to correspond to a vocalization start point and a vocalization end point of the articulation symbol, respectively so that the pronunciation pattern information of each articulation symbol is played as much as the corresponding vocalization length, and assigns the pronunciation pattern information of the transition section as a key frame to be displayed only at a specific point in the corresponding transition section. Subsequently, the animation generating unit 805 generates an animation of each articulator by filling a vacant general frame between key frames (namely, pronunciation pattern information) by means of an animation interpolating technique, and composes animations of articulators into a single vocal organ animation. At this time, in the case two or more kinds of pronunciation pattern information are present for a specific transition section assigned between articulation symbols, the animation generating unit 805 assigns the pronunciation pattern information so that two or more kinds of pronunciation pattern information are spaced at regular time intervals, and performs interpolation between the corresponding key frame assigned to the transition section and an adjacent key frame, thereby filling a vacant general frame in the corresponding transition section. Meanwhile, in the case pronunciation pattern information of a transition section assigned between articulation symbols is not detected by the pronunciation pattern detecting unit 804, the animation generating unit 805 performs interpolation between pronunciation pattern information of two articulation symbols adjacent to the transition section without assigning the pronunciation pattern information of the corresponding transition section, thereby generating a general frame to be assigned to the transition section.

Next, the animation generating unit 805 composes a plurality of animations respectively generated for articulators into a single animation to generate a vocal organ animation corresponding to the phonetic value constitution information at the input unit 101 (S1117). Next, the display unit 806 displays a detail phonetic value and a transition section included in the phonetic value constitution information, an articulation symbol included in the articulation constitution information of each articulator, a vocalization length of the articulation symbol, a transition section assigned between articulation symbols and vocal organ animation to a display means such as a liquid crystal display (S1119).

Meanwhile, the apparatus for generating a vocal organ animation may receive reset information about the vocal organ animation, displayed by the display unit 806, from the user. In other words, the animation coordinating unit 807 receives reset information about at least one of a phonetic value list representing a sound value of character information, a vocalization length of each phonetic value, a transition section assigned between phonetic values, a detail phonetic value included in the phonetic value constitution information, a vocalization length of each detail phonetic value, a transition section assigned between detail phonetic values, an articulation symbol included in the articulation constitution information, a vocalization length of each articulation symbol, a transition section assigned between articulation symbols, and pronunciation pattern information, through the input unit 101 from the user. In this case, the animation coordinating unit 807 checks the reset information input by the user, and selectively transmits the reset information to the phonetic value constitution information generating unit 103, the transition section allocating unit 105, the phonetic value context applying unit 107, the articulation constitution information generating unit 802, and the pronunciation pattern detecting unit 806.

Accordingly, the phonetic value constitution information generating unit 103 regenerates phonetic value constitution information based on the reset information, or the transition section allocating unit 105 assigns a transition section between adjacent phonetic values again. In other cases, the phonetic value context applying unit 107 reconstitutes phonetic value constitution information based on the reset information once more, or the pronunciation pattern detecting unit 804 changes the pronunciation pattern information extracted in Step S1115 into the reset pronunciation pattern information. Meanwhile, if reset information about an articulation symbol included in the articulation constitution information, a vocalization length of each articulation symbol, and a transition section assigned between adjacent articulation symbols is received, the animation coordinating unit 807 transmits the reset information to the articulation constitution information generating unit 802, and the articulation constitution information generating unit 802 regenerates articulation constitution information of each articulator based on the reset information.

In other words, if the reset information is received from the user through the animation coordinating unit 807, the apparatus for generating a vocal organ animation according to another embodiment of the present disclosure animation executes Steps S1103 to S1119 entirely or a part thereof selectively again according to the reset information.

While this specification contains many features, the features should not be construed as limitations on the scope of the disclosure or of the appended claims. Certain features described in the context of separate exemplary embodiments can also be implemented in combination. Conversely, various features described in the context of a single exemplary embodiment can also be implemented in multiple exemplary embodiments separately or in any suitable subcombination.

Although the drawings describe the operations in a specific order, one should not interpret that the operations are performed in a specific order as shown in the drawings or successively performed in a continuous order, or all the operations are performed to obtain a desired result. Multitasking or parallel processing may be advantageous under any environment. Also, it should be understood that all exemplary embodiments do not require the distinction of various system components made in this description. The program components and systems may be generally implemented as a single software product or multiple software product packages.

The method of the present disclosure described above may be implemented as a program and stored in a recording medium (CD-ROM, RAM, ROM, floppy disc, hard disc, magneto-optical disc or the like) in a computer-readable form. This process may be easily implemented by those having ordinary skill in the art and thus is not described in more detail here.

Various substitutions, changes and modifications can be made to the present disclosure described above by those having ordinary skill in the art within the scope of the present disclosure and the present disclosure is not limited to the above embodiments and the accompanying drawings.

### INDUSTRIAL APPLICABILITY

It is expected that the present disclosure may contribute to correcting pronunciations of a foreign language learner and activating education industries by generating an animation about a pronunciation pattern of a native speaker and providing the animation to the foreign language learner.

What is claimed is:

1. A method for generating a vocal organ animation corresponding to phonetic value constitution information which is information about a phonetic value list to which vocalization lengths are allocated, by using an apparatus for generating a vocal organ animation, the method comprising:
a transition section assigning step for assigning a part of vocalization lengths of every two adjacent phonetic values included in the phonetic value constitution information as a transition section between the corresponding two adjacent phonetic values;
a detail phonetic value extracting step for checking an adjacent phonetic value of each phonetic value included in the phonetic value constitution information and then extracting a detail phonetic value corresponding to each phonetic value based on the adjacent phonetic value to generate a detail phonetic value list corresponding to the phonetic value list;
a reconstituting step for reconstituting the phonetic value constitution information by including the generated detail phonetic value list in the phonetic value constitution information;
a pronunciation pattern information detecting step for detecting pronunciation pattern information corresponding to each detail phonetic value and each transition section included in the reconstituted phonetic value constitution information; and
an animation generating step for generating a vocal organ animation corresponding to the phonetic value constitution information by assigning the detected pronunciation pattern information based on the vocalization length of each detail phonetic value and the transition section and performing interpolation to the assigned pronunciation pattern information.

2. The method for generating a vocal organ animation according to claim 1,
wherein the animation generating step generates a vocal organ animation by assigning pronunciation pattern information detected for each detail phonetic value to a start point and an end point corresponding to the vocalization length of the detail phonetic value and performing interpolation to the pronunciation pattern information assigned to the start point and the end point.

3. The method for generating a vocal organ animation according to claim 2,
wherein the animation generating step generates a vocal organ animation by assigning zero or at least one kind of pronunciation pattern information detected for each transition section to the corresponding transition section and performing interpolation to each pair of adjacent pronunciation pattern information existing from pronunciation pattern information of a detail phonetic value just before the transition section till pronunciation pattern information of a following detail phonetic value.

4. The method for generating a vocal organ animation according to claim 1, further comprising:
receiving reset information about at least one of the phonetic value, the detail phonetic value, the vocalization length, the transition section and the pronunciation pattern information from a user; and
changing the phonetic value, the detail phonetic value, the vocalization length, the transition section or the pronunciation pattern information based on the received reset information.

5. A method for generating a vocal organ animation corresponding to phonetic value constitution information which is information about a phonetic value list to which vocalization lengths are allocated, by using an apparatus for generating a vocal organ animation, the method comprising:
a transition section assigning step for assigning a part of vocalization lengths of every two adjacent phonetic values included in the phonetic value constitution information as a transition section between the corresponding two adjacent phonetic values;
a detail phonetic value extracting step for checking an adjacent phonetic value of each phonetic value included in the phonetic value constitution information and then extracting a detail phonetic value corresponding to each phonetic value based on the adjacent phonetic value to generate a detail phonetic value list corresponding to the phonetic value list;
a reconstituting step for reconstituting the phonetic value constitution information by including the generated detail phonetic value list in the phonetic value constitution information;
an articulation symbol extracting step for extracting an articulation symbol of each articulator which corresponds to each detail phonetic value included in the reconstituted phonetic value constitution information;
an articulation constitution information generating step for generating articulation constitution information of each articulator which includes the extracted articulation symbol, the vocalization length of each articulation symbol and the transition section;
a pronunciation pattern information detecting step for detecting pronunciation pattern information of each articulator which corresponds to each articulation symbol included in the articulation constitution information and each transition section assigned between articulation symbols; and
an animation generating step for assigning the detected pronunciation pattern information based on the vocalization length of each articulation symbol and the transition section and then performing interpolation to the assigned pronunciation pattern information to generate an animation of each articulator which corresponds to the articulation constitution information, and composing the generated animations to generate a single vocal organ animation corresponding to the phonetic value constitution information.

6. The method for generating a vocal organ animation according to claim 5, wherein the articulation constitution information generating step includes:
checking how much an articulation symbol extracted corresponding to each detail phonetic value participates in vocalization of the corresponding detail phonetic value (hereinafter, referred to as “the degree of vocalization involvement”); and
generating articulation constitution information by resetting a vocalization length of each articulation symbol or a transition section assigned between articulation symbols according to the checked degree of vocalization involvement.

7. The method for generating a vocal organ animation according to claim 5 or 6,
wherein the animation generating step generates an animation of each articulator corresponding to the articulation constitution information by assigning pronunciation pattern information detected for each articulation symbol to a start point and an end point corresponding to the vocalization length of the corresponding articulation symbol and performing interpolation to the pronunciation pattern information assigned to the start point and the end point.

8. The method for generating a vocal organ animation according to claim 7,
wherein the animation generating step generates an animation of each articulator corresponding to the articulation constitution information by assigning zero or at least one kind of pronunciation pattern information detected for each transition section to the corresponding transition section and performing interpolation to each pair of adjacent pronunciation pattern information existing from pronunciation pattern information of an articulation symbol just before the transition section till pronunciation pattern information of a following articulation symbol.

9. The method for generating a vocal organ animation according to claim 5 or 6, further comprising:
receiving reset information about at least one of the phonetic value, the detail phonetic value, the articulation symbol, the vocalization length of each detail phonetic value, the vocalization length of each articulation symbol, the transition section and the pronunciation pattern information from a user; and
changing the phonetic value, the detail phonetic value, the articulation symbol, the vocalization length of each detail phonetic value, the vocalization length of each articulation symbol, the transition section or the pronunciation pattern information based on the received reset information.

10. An apparatus for generating a vocal organ animation corresponding to phonetic value constitution information which is information about a phonetic value list to which vocalization lengths are allocated, the apparatus comprising:
a transition section assigning means for assigning a part of vocalization lengths of every two adjacent phonetic values included in the phonetic value constitution information as a transition section between the corresponding two adjacent phonetic values;
a phonetic value context applying means for checking an adjacent phonetic value of each phonetic value included in the phonetic value constitution information, then extracting a detail phonetic value corresponding to each phonetic value based on the adjacent phonetic value to generate a detail phonetic value list corresponding to the phonetic value list, and reconstituting the phonetic value constitution information by including the generated detail phonetic value list in the phonetic value constitution information;
a pronunciation pattern information detecting means for detecting pronunciation pattern information corresponding to each detail phonetic value and each transition section included in the reconstituted phonetic value constitution information; and
an animation generating means for generating a vocal organ animation corresponding to the phonetic value constitution information by assigning the detected pronunciation pattern information based on the vocalization length of each detail phonetic value and the transition section and performing interpolation to the assigned pronunciation pattern information.

11. The apparatus for generating a vocal organ animation according to claim 10,
wherein the animation generating means generates a vocal organ animation by assigning pronunciation pattern information detected for each detail phonetic value to a start point and an end point corresponding to the vocalization length of the detail phonetic value and performing interpolation to the pronunciation pattern information assigned to the start point and the end point.

12. The apparatus for generating a vocal organ animation according to claim 11,
wherein the animation generating means generates a vocal organ animation by assigning zero or at least one kind of pronunciation pattern information detected for each transition section to the corresponding transition section and performing interpolation to each pair of adjacent pronunciation pattern information existing from pronunciation pattern information of a detail phonetic value just before the transition section till pronunciation pattern information of a following detail phonetic value.

13. The apparatus for generating a vocal organ animation according to claim 10, further comprising:
an animation coordinating means for giving an interface for regenerating the vocal organ animation and receiving reset information about at least one of the phonetic value, the detail phonetic value, the vocalization length, the transition section and the pronunciation pattern information from a user through the interface.

14. An apparatus for generating a vocal organ animation corresponding to phonetic value constitution information which is information about a phonetic value list to which vocalization lengths are allocated, the apparatus comprising:
a transition section assigning means for assigning a part of vocalization lengths of every two adjacent phonetic values included in the phonetic value constitution information as a transition section between the corresponding two adjacent phonetic values;
a phonetic value context applying means for checking an adjacent phonetic value of each phonetic value included in the phonetic value constitution information, then extracting a detail phonetic value corresponding to each phonetic value based on the adjacent phonetic value to generate a detail phonetic value list corresponding to the phonetic value list, and reconstituting the phonetic value constitution information by including the generated detail phonetic value list in the phonetic value constitution information;
an articulation constitution information generating means for extracting an articulation symbol of each articulator which corresponds to each detail phonetic value included in the reconstituted phonetic value constitution information and then generating articulation constitution information of each articulator which includes the extracted one or more articulation symbol, the vocalization length of each articulation symbol and the transition section;
a pronunciation pattern detecting means for detecting pronunciation pattern information of each articulator which corresponds to each articulation symbol included in the articulation constitution information and each transition section assigned between articulation symbols; and
an animation generating means for assigning the detected pronunciation pattern information based on the vocalization length of each articulation symbol and the transition section and then performing interpolation to the assigned pronunciation pattern information to generate an animation of each articulator which corresponds to the articulation constitution information, and composing the generated animations to generate a single vocal organ animation corresponding to the phonetic value constitution information.

15. The apparatus for generating a vocal organ animation according to claim 14, wherein the articulation constitution information generating means checks how much an articulation symbol extracted corresponding to each detail phonetic value participates in vocalization of the corresponding detail phonetic value for each articulation organ (hereinafter, referred to as “the degree of vocalization involvement”), and generates articulation constitution information by resetting a vocalization length of each articulation symbol or a transition section assigned between articulation symbols according to the checked degree of vocalization involvement.

16. The apparatus for generating a vocal organ animation according to claim 14 or 15,
wherein the animation generating means generates an animation of each articulator corresponding to the articulation constitution information by assigning pronunciation pattern information detected for each articulation symbol to a start point and an end point corresponding to the vocalization length of the corresponding articulation symbol and performing interpolation to the pronunciation pattern information assigned to the start point and the end point.

17. The apparatus for generating a vocal organ animation according to claim 16,
wherein the animation generating means generates an animation of each articulator corresponding to the articulation constitution information by assigning zero or at least one kind of pronunciation pattern information detected for each transition section to the corresponding transition section and performing interpolation to each pair of adjacent pronunciation pattern information existing from pronunciation pattern information of an articulation symbol just before the transition section till pronunciation pattern information of a following articulation symbol.

18. The apparatus for generating a vocal organ animation according to claim 14 or 15, further comprising:
an animation coordinating means for giving an interface for regenerating the vocal organ animation and receiving reset information about at least one of the phonetic value, the detail phonetic value, the vocalization length, the transition section and the pronunciation pattern information from a user through the interface.
